(19) United States
(12) Patent Application Publication
(10) Pub. No.: US 2026/0329142 A1
(43) Pub. Date: Oct. 22, 2026

(54) BIAS-FREE MACH ZEHNDER MODULATOR

(71) Applicant: OPTILAB, LLC, Phoenix, AZ (US)

(72) Inventors: Henry H. Hung, Paradise Valley, AZ (US); Ke Huang, Phoenix, AZ (US); Leijun Yin, Tempe, AZ (US); Xiaoyan Ying, Tempe, AZ (US)

(21) Appl. No.: 19/186,245

(22) Filed: Apr. 22, 2025

(51) Int. Cl. G02F 1/21; G02F 1/035; G02F 1/225

(52) U.S. Cl. CPC G02F 1/212; G02F 1/0356; G02F 1/2255

(57) ABSTRACT

A Mach Zehnder (MZ) modulator, including: an MZ interferometer including an optical signal input, an RF signal input, a first optical signal output, and a second optical signal output; and a directional coupler, including: a first optical waveguide coupled between a first port and a second port, wherein the first optical waveguide includes a first segment with a first index of refraction coupled in series with a second segment with a second index of refraction, wherein the first port is coupled to the first optical signal output of the MZ interferometer; and a second optical waveguide coupled between a third port and a fourth port, wherein the second optical waveguide includes a third segment with a third index of refraction coupled in series with a fourth segment with a fourth index of refraction, wherein the third port is coupled to the second optical signal output of the MZ interferometer.

### BACKGROUND

### Field

The present disclosure pertains to the field of electro-optic (EO) modulators, and in particular, to a bias-free Mach Zehnder (MZ) modulator.

### Background

A Mach Zehnder (MZ) modulator is configured to modulate an optical signal with a radio frequency (RF) signal to generate an output modulated optical signal for transmission. In the past, such MZ modulator included a bias interferometer section to set the transfer function of the MZ modulator to its most linear region, the transfer function being the power of the output modulated optical signal versus the power or voltage/amplitude of the RF signal. However, as discussed herein, there are many drawbacks associated with the bias interferometer section.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

A Mach Zehnder (MZ) modulator, comprising: an MZ interferometer including an optical signal input, a radio frequency (RF) signal input, a first optical signal output, and a second optical signal output; and a directional coupler, comprising: a first optical waveguide coupled between a first port and a second port, wherein the first optical waveguide includes a first segment with a first index of refraction coupled in series with a second segment with a second index of refraction, wherein the first port is coupled to the first optical signal output of the MZ interferometer; and a second optical waveguide coupled between a third port and a fourth port, wherein the second optical waveguide includes a third segment with a third index of refraction coupled in series with a fourth segment with a fourth index of refraction, wherein the third port is coupled to the second optical signal output of the MZ interferometer.

A Mach Zehnder (MZ) modulator, comprising: an MZ interferometer configured to modulate an input optical signal with a radio frequency (RF) signal to generate first and second modulated optical signals without being biased with a bias voltage; and a directional coupler configured to combine the first and second modulated optical signals to generate an output optical signal whose power varies substantially linear with an amplitude of the RF signal.

A method of manufacturing a Mach Zehnder (MZ) modulator, including: forming first and second MZ interferometer optical waveguides with a first index of refraction in an electro-optic (EO) material; forming first and second coupler optical waveguides with the first index of refraction in the EO material, the first and second coupler optical waveguides being coupled to the first and second MZ interferometer optical waveguides, respectively; exposing a first segment of the first coupler optical waveguide to a femtosecond laser inscription to increase its first index of refraction while masking a second segment of the first optical waveguide from the femtosecond laser inscription; and exposing a fourth segment of the second coupler optical waveguide to the femtosecond laser inscription to increase its first index of refraction while masking a third segment of the second optical waveguide from the femtosecond laser inscription.

A method of manufacturing a Mach Zehnder (MZ) modulator, including: forming a mask on an electro-optic (EO) material with two slots at locations where first and second segments of first and second coupler optical waveguides of a directional coupler are to be formed, respectively; subjecting the EO material to a bath of melted benzoic acid to promote proton exchange at the locations where first and second segments of first and second coupler optical waveguides of a directional coupler are to be formed, respectively; forming the first and second coupler optical waveguides coupled to first and second interferometer optical waveguides in the EO material, respectively; forming signal coplanar electrode laterally between the first and second interferometer optical waveguides, and ground coplanar electrodes laterally on either sides of the first and second interferometer optical waveguides, respectively; and annealing the first and second coupler optical waveguides to form the first and second segments and third and fourth segments of the first and second coupler optical waveguide while applying an input optical signal to the first and second interferometer optical waveguides, applying a radio frequency (RF) signal to the signal coplanar electrode, and monitoring an output optical signal from the first coupler optical waveguide, wherein the first and second segments each has a first index of refraction greater than a second index of refraction of each of the third and fourth segments.

### BRIEF DESCRIPTION OF THE DRAWINGS

FIG. 1 illustrates a schematic diagram of an example biased Mach Zehnder (MZ) electro-optic (EO) modulator in accordance with an aspect of the disclosure.

FIG. 2 illustrates a graph of an example transfer function associated with the biased Mach Zehnder (MZ) electro-optic (EO) modulator of FIG. 1 in accordance with another aspect of the disclosure.

FIG. 3 illustrates a schematic diagram of another example biased Mach Zehnder (MZ) electro-optic (EO) modulator in accordance with another aspect of the disclosure.

FIG. 4A illustrates a schematic diagram of an example bias-free Mach Zehnder (MZ) electro-optic modulator in accordance with another aspect of the disclosure.

FIG. 4B illustrates a graph of an example transfer function associated with the bias-free Mach Zehnder (MZ) electro-optic modulator of FIG. 4A in accordance with another aspect of the disclosure.

FIGS. 5A-5D illustrate top and cross-sectional views of the bias-free Mach Zehnder (MZ) electro-optic modulator of FIG. 4 at various stages of an example method of manufacturing the same in accordance with another aspect of the disclosure.

FIGS. 6A-6D illustrate top and cross-sectional views of the bias-free Mach Zehnder (MZ) electro-optic modulator of FIG. 4 at various stages of another example method of manufacturing the same in accordance with another aspect of the disclosure.

FIG. 7 shows a top view representation of an example multi-channel electro-optic (EO) transmitter in accordance with another aspect of the disclosure.

FIG. 8 shows a block diagram of another example multi-channel electro-optic (EO) transmitter in accordance with another aspect of the disclosure.

### DETAILED DESCRIPTION

To facilitate a better understanding of the solutions presented in this disclosure, detailed descriptions of the technical aspects are provided below in conjunction with the accompanying drawings. It is evident that the embodiments described here are only a subset of all possible implementations and do not represent the entirety of the disclosure. All other embodiments that can be derived by those skilled in the art without requiring creative effort should fall within the scope of protection of this disclosure.

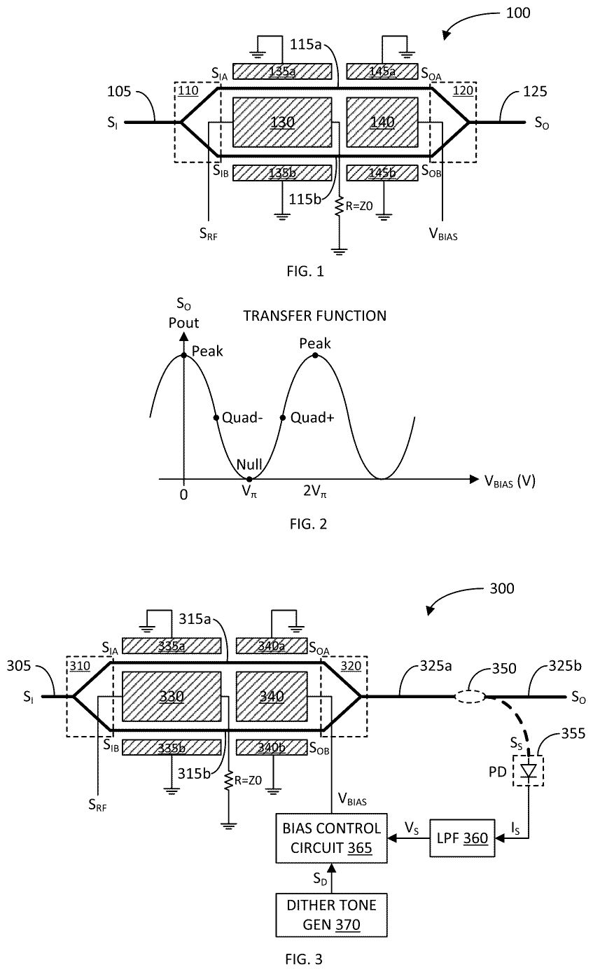

FIG. 1 illustrates a schematic diagram of an example biased Mach Zehnder (MZ) (electro-optic) modulator 100 in accordance with an aspect of the disclosure. The MZ modulator 100 includes an input optical waveguide 105, a 1×2 optical splitter 110, a pair of interferometer optical waveguides 115a and 115b, a 2×1 optical combiner 120, and an output optical waveguide 125. Each of the optical waveguide components 105, 110, 115a/115b, 120, and 125 may be made of lithium niobate (LN) or other suitable electro-optic (EO) materials.

The MZ modulator 100 includes a radio frequency (RF) signal coplanar electrode 130, a pair of grounded coplanar electrodes 135a and 135b associated with the RF signal coplanar electrode 130, a bias electrode 140, and a pair of grounded coplanar electrodes 145a and 145b associated with the bias electrode 140. The RF signal coplanar electrode 130 includes a first (e.g., left) end configured to receive an input RF signal S_{RF}. A termination resistor R, with a characteristic impedance Z0 (e.g., 50 Ohms (Ω)) associated with the signal coplanar electrode 130, is coupled between a second (e.g., right) end of the RF signal coplanar electrode 130 and ground. The bias electrode 140 is configured to receive a bias voltage V_{BIAS}.

The input optical waveguide 105 is configured to receive an input optical signal S_{I} (e.g., a continuous wave (CW) laser signal). The 1×2 optical splitter 110 is configured to split the input optical signal S_{I} into a pair of unmodulated optical signals S_{IA} and S_{IB}. The pair of interferometer optical waveguides 115a and 115b are configured to phase modulate the unmodulated optical signals S_{IA} and S_{OB} with the RF signal S_{RF} based on the bias voltage V_{BIAS} to generate a pair of modulated optical signals S_{OA} and S_{OB}. The 2×1 optical splitter 120 is configured to combine the modulated optical signals S_{OA} and S_{OB} to generate an output optical signal S_{O}. The output optical waveguide 125 is configured to direct/guide the output optical signal S_{O} to an output.

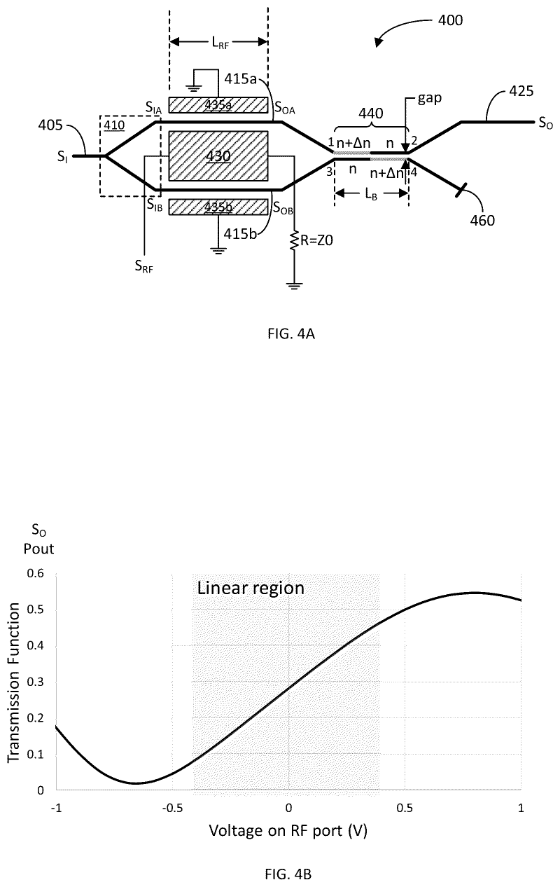

FIG. 2 illustrates a graph of an example transfer function associated with the biased MZ modulator 100 in accordance with another aspect of the disclosure. The vertical axis represents the power of the output optical signal S_{O}. The horizontal axis represents the bias voltage V_{BIAS} in Volt (V). As shown, the transfer function exhibits a co-sinusoidal response with a first peak at V_{BIAS}=0V, a null at V_{BIAS}=V_{π}, and a second peak at V_{BIAS}=2V_{π}. Also shown, the transfer function includes a negative-slope quadrature point (Quad−) at V_{BIAS}=1/2V_{π}, and a positive-slope quadrature point (Quad+) at V_{BIAS}=3/2V_{π}. Note that the transfer function is most linear at the quadrature points Quad− and Quad+. Thus, it is desirable for the RF signal S_{RF} to vary about either one of the quadrature points to produce a substantially linear and stable response of the power of the output optical signal S_{O} with the voltage or amplitude of the RF signal S_{RF}.

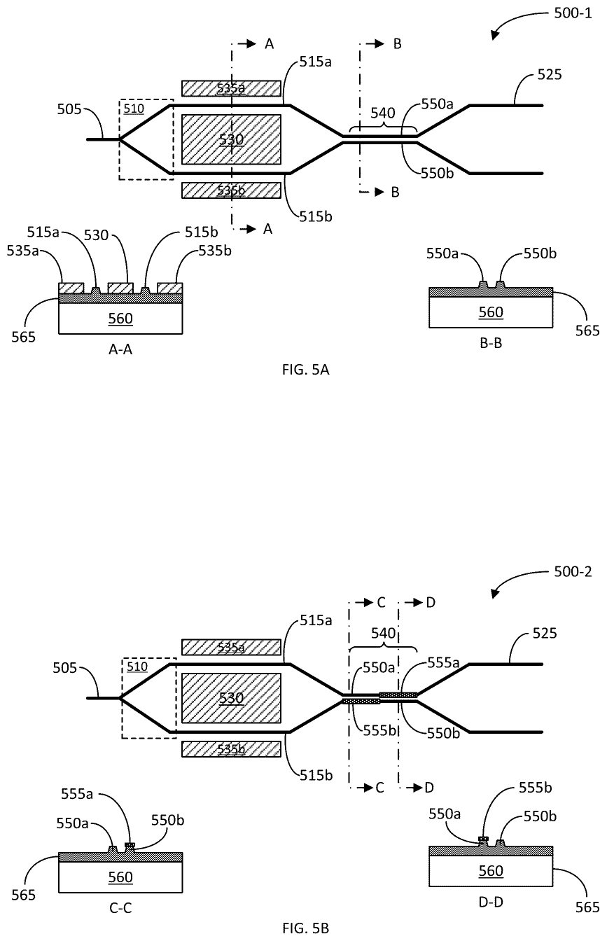

FIG. 3 illustrates a schematic diagram of another example biased Mach Zehnder (MZ) electro-optic (EO) modulator 300 in accordance with another aspect of the disclosure. The MZ modulator 300 is similar to MZ modulator 100 including many of the same/similar elements as indicated by the same reference numbers with the exception that their most significant digit (MSD) is a “3” for MZ modulator 300 instead of a “1” for MZ modulator 100. The MZ modulator 300 further includes a bias voltage generating and control circuit configured to generate and control a bias voltage V_{BIAS} for setting and maintaining the quadrature point of the MZ interferometer (e.g., the interferometer optical waveguides 315a/315b, and coplanar RF electrodes 330 and 335a/335b, and bias electrodes 340 and 340a/340b). The bias voltage generating and control circuit includes an optical coupler 350, a photodetector (PD) 355, a low pass filter (LPF) 360, a bias control circuit 365, and a dither tone generator 370.

The optical coupler 350 is coupled between a first output waveguide segment 325a and a second output waveguide segment 325b. The PD 355 includes an input coupled to the optical coupler 350 to receive a sample output optical signal S_{S}. The PD 355 is configured to generate a sample output current I_{S} based on the sample output optical signal S_{S}. The LPF 360 is configured to filter the sample output current Is to generate a sample output voltage V_{S}. The bias control circuit 365 is configured to receive the sample output voltage V_{S} and a dither tone signal S_{D} generated by the dither tone generator 370. The bias control circuit 365 is configured to generate the bias voltage V_{BIAS} based on the sample output voltage V_{S} and the dither tone signal S_{D}. As mentioned, the bias voltage V_{BIAS} sets and maintains the quadrature operating point of the MZ modulator interferometer.

There are several drawbacks associated with the quadrature point biasing the MZ modulator 300. First, the bias interferometer section of the MZ modulator 300 including the bias coplanar electrode 340 and associated ground coplanar electrodes 340a and 340b require significant lengths (e.g., by 5-10 millimeters (mm)) to keep the bias voltage V_{BIAS} relatively low and affordable. Due to the bias voltage control mechanism, the bias point of the MZ modulator 300 may easily shift over time in response to temperature fluctuations, aging effects, internal charge distribution, and bias voltage noise. The bias voltage control mechanism still being based on the phase delay between the two arms 115a/115b of the interferometer is sensitive to external impact, and lengthy long arm change causes large bias point drifts.

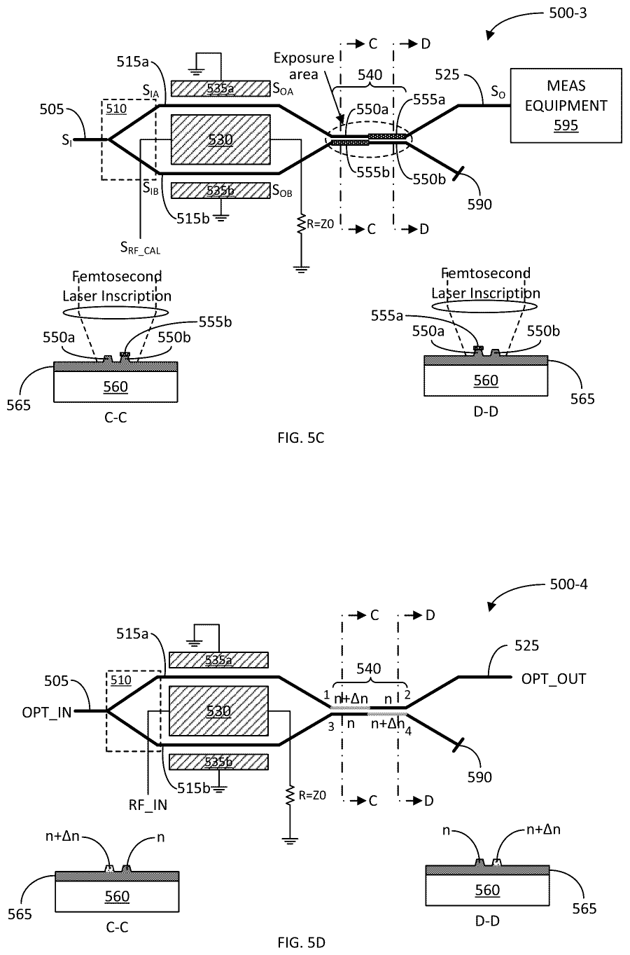

FIG. 4A illustrates a schematic diagram of an example bias-free Mach Zehnder (MZ) (electro-optic) modulator 400 in accordance with another aspect of the disclosure. As the name indicates, the bias-free MZ modulator 400 may not include bias voltage related circuitry for the MZ interferometer. More specifically, the bias-free MZ modulator 400 is similar to MZ modulator 300 but may not include the bias coplanar electrode 340, the associated ground coplanar electrodes 340a/340b, and the bias voltage generating and control circuit including the optical coupler 350, PD 355, LPF 360, dither tone generator 370, and bias control circuit 365.

From an optical perspective, the MZ modulator 400 includes an input optical waveguide 405, a 1×2 optical splitter 410, a pair of interferometer optical waveguides 415a/415b, a directional optical coupler 440 including an optical termination 460, and an output optical waveguide 425. From an electrical perspective, the MZ modulator 400 includes a signal coplanar electrode 430, a pair of associated ground coplanar electrodes 435a and 435b, and a termination resistor R=Z0 (where Z0 is a characteristic impedance (e.g., 50Ω) of the signal coplanar electrode 430).

The input optical waveguide 405 is configured to receive an input optical signal S_{I} (e.g., a CW laser). The 1×2 optical splitter 410 is configured to split the input optical signal S_{I} into a pair of unmodulated optical signals S_{IA} and S_{IB}. A first (e.g., left) end of the signal coplanar electrode 430 is configured to receive an RF signal S_{RF}. The termination resistor R=Z0 is coupled between a second (e.g., right) end of the signal coplanar electrode 430 and ground. The interferometer optical waveguide 415a extends parallel with and laterally between the signal coplanar electrode 430 and the ground coplanar electrode 435a for a length L_{RF}. Similarly, the interferometer optical waveguide 415b extends parallel with and laterally between the signal coplanar electrode 430 and the ground coplanar electrode 435b for the same length LRF.

The aforementioned configuration of the interferometer optical waveguides 415a/415b and coplanar signal/ground electrodes 430/435a/435b form the MZ interferometer of the MZ modulator 400. In such configuration, the unmodulated optical signals S_{IA} and S_{IB} get phase modulated with the RF signal S_{RF} while they propagate from first (e.g., left) ends to second (e.g., right) ends of the interferometer optical waveguides 415a and 415b, respectively. Accordingly, a pair of modulated optical signals S_{OA} and S_{OB} are generated at the second ends of the interferometer optical waveguide 415a and 415b, respectively.

The directional optical coupler 440 is configured to set the transfer function operating point of the MZ interferometer so that it operates substantially at the quadrature point for improved linearity and stability. The directional optical coupler 440 includes a first “1” port coupled to the interferometer optical waveguides 415a to receive the modulated optical signal S_{OA}. The directional optical coupler 440 includes a third “3” port coupled to the interferometer optical waveguides 415b to receive the modulated optical signal S_{OB}. The directional optical coupler 440 is further configured to combine the modulated optical signals S_{OA} and S_{OB} to generate an output optical signal at the second “2” port thereof.

The directional optical coupler 440 includes a first pair of optical waveguide segments with respective indices of refraction n+Δn and n coupled in series in that order between the first “1” port and a second “2” port. The directional optical coupler 440 includes a second pair of optical waveguide segments with indices of refraction n and n+Δn coupled in series in that order between the third “3” port and a fourth “4” port. The length of each of the optical waveguide segments is substantially ½ of the coupling length L_{B} of the directional optical coupler 440. The waveguide segment n+Δn between ports 1-2 is evanescently coupled to (e.g., lies laterally adjacent to and separated by a gap, and extends parallel with along half the coupling length of) the waveguide section n between ports 3-4. Similarly, the waveguide segment n between ports 1-2 is evanescently coupled to (e.g., lies adjacent to and separated by a gap, and extends parallel with along half the coupling length of) the waveguide segment n+Δn between ports 3-4. The optical termination is coupled to the fourth “4” port of the directional coupler 440. The output optical waveguide 440 is coupled to the second “2” port of the directional optical coupler 440 to direct the output optical signal S_{O} to an output.

The coupling length L_{B} of the directional coupler 440 depends on: (1) the gap between the optical waveguide segments n+Δn/n between ports 1-2 and the optical waveguide segments n/n+Δn between ports 3-4; (2) the waveguide width of the optical waveguide segments n+Δn/n and n/n+Δn; and (3) and the waveguide refractive index of the optical waveguide segments n+Δn/n and n/n+Δn. For example, the coupling length L_{B} of the directional coupler 440 may be a few hundreds of micrometers (μm). Quadrature point is realized by achieving a specified optical power coupling ratio between the two waveguides of the directional coupler 440. The specified optical power coupling ratio once achieved is very resistive to temperature change, vibration, and external impact. The higher or stepped n+Δn optical waveguide segments can achieve the right optical power coupling ratio to realize the quadrature point operation of the MZ modulator 400.

As an example, for a particular application: the length LRF of the MZ interferometer may be two (2) centimeters (cm); the length L_{B} of the directional coupler 440 may be 190 μm; the index of refraction n of the optical waveguides 405, 410, 415a/415b, 425, and the n segments of the directional coupler 440 may be 2.138; the index of refraction of the n+Δn optical waveguide segment of the directional coupler 440 may be 2.138+0.038*2.138; the width of the optical waveguides 405, 410, 415a/415b, 425, and the n segments of the directional coupler 440 may be 2 μm; and the gap between the optical segments n+Δn/n and n/n+Δn may be 0.3 μm.

FIG. 4B illustrates a graph of an example transfer function associated with the bias-free Mach Zehnder modulator 400 in accordance with another aspect of the disclosure. The vertical axis of the graph represents the power of the output optical signal S_{O}. The horizontal axis represents the voltage or amplitude of the RF signal S_{RF} at the RF port. Thus, by including and properly configuring the directional coupler 440 with the appropriate parameters (e.g., LB, n, n+Δn, waveguide width, coupler gap), the 0V or common mode voltage of the RF signal S_{RF} may be set to the shaded linear region of the transfer function so that the power of the output optical signal S_{O} varies substantially linear with the voltage or amplitude of the RF signal S_{RF}.

There are several advantages of the bias-free MZ modulator 400 compared to the biased MZ modulator 300. First, the bias-free MZ modulator 400 need not have a servo bias control circuit, which consumes power and occupies significant circuit footprint. Second, the bias-free MZ modulator 400 need not have a bias interferometer section, which may have a significant length of 5-10 mm compared to a 100 μm of the directional coupler 440, this results in significant circuit footprint savings for the bias-free MZ modulator 400. Third, the bias-free MZ modulator 400 has a quadrature point not subjected to bias voltage drift resulting in a quadrature point that is robust and substantially immune to external perturbations.

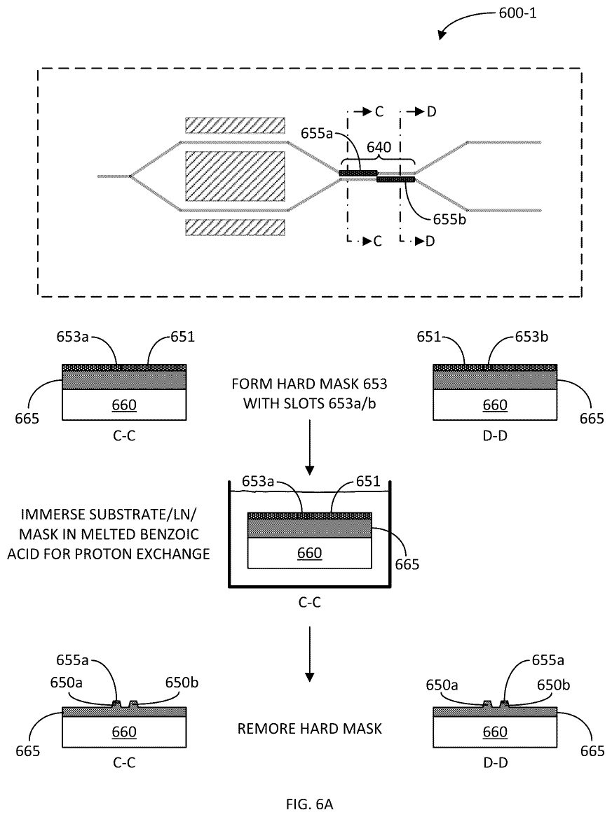

FIG. 5A illustrates top and cross-sectional views A-A and B-B of a bias-free Mach Zehnder (MZ) electro-optic (EO) modulator 500-1 at a particular stage of a first example method of manufacturing the same in accordance with another aspect of the disclosure. At this stage, the MZ interferometer of the bias-free MZ modulator 500-1 is formed over a modulator substrate 560 (e.g., Silicon (Si) substrate) including the electro-optic (EO) material 565 (e.g., Lithium Niobate (LN)) disposed over the modulator substrate 560. As illustrated in cross-sectional view A-A, the MZ interferometer section including the interferometer optical waveguides 515a/515b are formed in the EO material 565, and the coplanar electrodes 530 and 535a/535b are formed over the EO material 565. As illustrated in cross-sectional view B-B, the optical waveguides 550a/550b of the directional coupler 540 is formed in the EO material 565 disposed over the modulator substrate 560. Although not specifically shown in a cross-sectional view, the optical waveguides 505, 510, and 525 are also formed in the EO material 565 disposed over the modulator substrate 560.

FIG. 5B illustrates top and cross-sectional views C-C and D-D of the bias-free Mach Zehnder (MZ) electro-optic (EO) modulator 500-2 at a subsequent stage of the first example method of manufacturing the same in accordance with another aspect of the disclosure. According to the method, as illustrated in cross-sectional views C-C and D-D, hard masks 555a and 555b are formed over the coupler optical waveguides 550b/550a at locations where the n waveguide segments of the directional coupler 540 are to be formed, respectively.

FIG. 5C illustrates top and cross-sectional views C-C and D-D of the bias-free Mach Zehnder (MZ) electro-optic (EO) modulator 500-3 at a subsequent stage of the first example method of manufacturing the same in accordance with another aspect of the disclosure. At this stage, additional elements of the MZ modulator 500-3 may be formed to make the MZ modulator 500-3 operational including the grounding of the ground coplanar electrodes 535a/535b, the addition of the termination resistor R=Z0 at the second (e.g., right) end of the signal coplanar electrode 530, and the formation of the optical termination 590 of the directional coupler 540.

For controllably increasing the index of refraction of the exposed segments of the optical waveguides 550a/550b of the directional coupler 540 by the proper amount Δn, an input optical signal S_{I} is applied to the input optical waveguide 505 of the bias-free MZ modulator 500-3. Also, a calibration RF signal S_{RF_CAL} is provided to the first (e.g., left) end of the signal coplanar electrode 530. Further, a measurement equipment 595 is coupled to the output optical waveguide 525 of the bias-free MZ modulator 500-3 to receive the output optical signal S_{O}.

According to the method, as illustrated in cross-sectional views C-C and D-D, the exposed to-be-formed n+Δn segments of the optical waveguides 550a/550b of the directional coupler 540 are subjected to a femtosecond laser inscription while the power of the output optical signal S_{O} is being monitored by the measurement equipment 595. The n segments of the optical waveguides 550a/550b are masked from the femtosecond laser inscription. The exposed to-be-formed n+Δn segments of the optical waveguides 550a/550b of the directional coupler 540 are subjected to the femtosecond laser inscription until the measurement equipment 595 determines that the output power is at a certain power level. When that occurs, the femtosecond laser inscription of the exposed to-be-formed n+Δn segments is ceased. The femtosecond laser inscription increases the index of refraction of the exposed segments of the optical waveguides 550a/550b to form the n+Δn segments.

FIG. 5D illustrates top and cross-sectional views C-C and D-D of the bias-free Mach Zehnder (MZ) electro-optic (EO) modulator 500-4 at a final stage of the first example method of manufacturing the same in accordance with another aspect of the disclosure. Thus, as shown, the directional coupler 540 includes the n+Δn optical waveguide segment coupled in series with the n optical waveguide segment in that order between ports 1-2. Similarly, the directional coupler 540 includes the n optical waveguide segment coupled in series with the n+Δn optical waveguide segment in that order between ports 3-4.

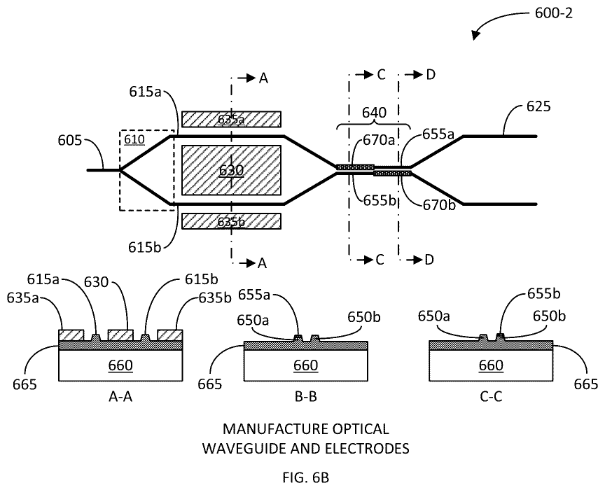

FIG. 6A illustrates top and cross-sectional views C-C and D-D of the bias-free Mach Zehnder (MZ) electro-optic (EO) modulator 600-1 at a particular stage of a second example method of manufacturing the same in accordance with another aspect of the disclosure. At this stage, the components of the bias-free MZ modulator 600-1 may not be formed as illustrated by the grey shading of the components. Also, an EO material (e.g., LN) 665 is formed over a substrate (e.g., Si) 660. According to the method, a hard mask 651 is including a pair of open slots 653a and 653b formed over the EO 665 at locations where the n+Δn optical waveguide segments of a directional coupler 640 are to be formed, respectively.

The MZ modulator 600-1 is then subjected to a bath of melted benzoic acid to produce a proton-exchange to increase the index of refraction of the EO material 665 at the locations underlying the pair of slots 653a and 653b. Then the hard mask is removed, leaving the photo exchange regions 655a and 655b.

FIG. 6B illustrates top and cross-sectional views A-A, C-C, and D-D of the bias-free Mach Zehnder (MZ) electro-optic (EO) modulator 600-2 at a subsequent stage of the second example method of manufacturing the same in accordance with another aspect of the disclosure. At this stage, most of the components of the MZ modulator 600-2 are formed. For example, the MZ interferometer segment including the interferometer optical waveguides 615a/615b are formed in the EO material 665, and the coplanar electrodes 630 and 635a/635b are formed over the EO material 665. Although not specifically shown in a cross-sectional view, the optical waveguides 605, 610, and 625 are also formed in the EO material 665.

FIG. 6C illustrates top and cross-sectional views C-C and D-D of the bias-free Mach Zehnder (MZ) electro-optic (EO) modulator 600-3 at a subsequent stage of the second example method of manufacturing the same in accordance with another aspect of the disclosure. At this stage, additional elements of the MZ modulator 600-3 may be formed to make the MZ modulator 600-3 operational including the grounding of the ground coplanar electrodes 635a/635b, the addition of the termination resistor R =ZO at the second (e.g., right) end of the signal coplanar electrode 630, and the formation of the optical termination 690 of the directional coupler 640.

For controllably setting the indices of refractions n and n+Δn of the segments of the optical waveguides 650a/650b of the directional coupler 640, an input optical signal S_{I} is applied to the input optical waveguide 605 of the bias-free MZ modulator 600-3. Also, a calibration RF signal S_{RF_CAL} is provided to the first (e.g., left) end of the signal coplanar electrode 630. Further, a measurement equipment 695 is coupled to the output optical waveguide 625 of the bias-free MZ modulator 600-3 to receive the output optical signal S_{O}.

According to the method, as illustrated in cross-sectional views C-C and D-D, the EO material 665 is subjected to an annealing process while the power of the output optical signal S_{O} is being monitored by the measurement equipment 695. When the measurement equipment 695 determines that the power of the output optical signal S_{O} is at a specified power level, the annealing process is ceased. The annealing process makes the index of refraction n to be substantially uniform throughout the EO material 665, while making the index of refraction at the previously open slot area to be at n+Δn.

FIG. 6D illustrates top and cross-sectional views C-C, and D-D of the bias-free Mach Zehnder (MZ) electro-optic (EO) modulator 600-4 at a final stage of the second example method of manufacturing the same in accordance with another aspect of the disclosure. Thus, as shown, the directional coupler 640 includes the n+Δn optical waveguide segment coupled in series with the n optical waveguide segment in that order between ports 1-2. Similarly, the directional coupler 640 includes the n optical waveguide segment coupled in series with the n+Δn optical waveguide segment in that order between ports 3-4.

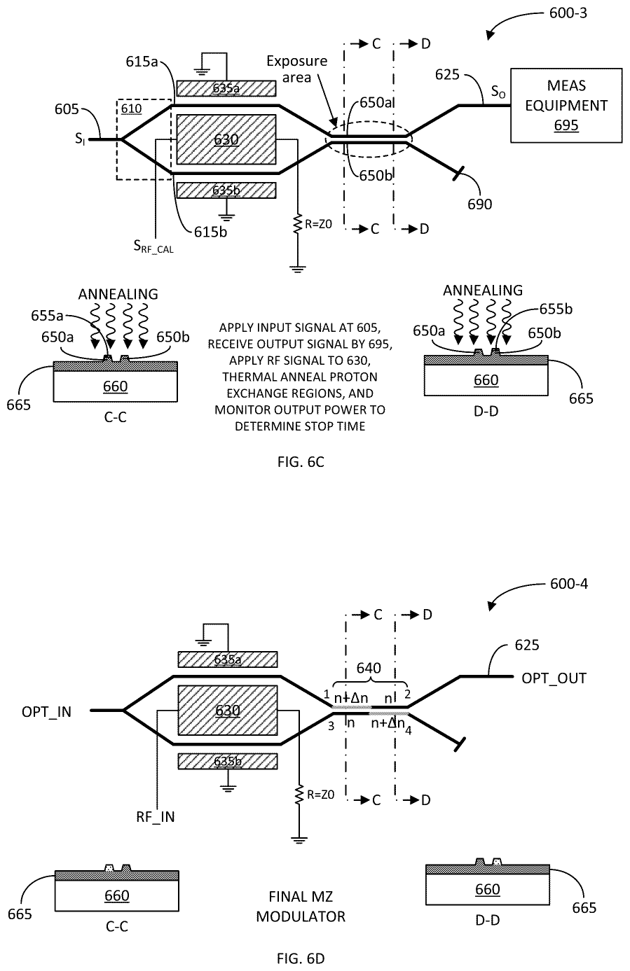

FIG. 7 shows a top view representation of an example multi-channel electro-optic (EO) transmitter 700 in accordance with another aspect of the disclosure. In this example, the multi-channel EO transmitter 700 includes four (4) channels, but it shall be understood that it may be configured to include more or less channels.

In particular, the multi-channel EO transmitter 700 may be implemented in an integrated circuit (IC) 710. The multi-channel EO transmitter 700 includes a 1×4 optical splitter 720 including an input coupled to or serving as an input optical port (OPT IN). The 1×4 optical splitter 720 includes four (4) outputs coupled to optical inputs of a set of four (4) bias-free MZ modulators 730-1 to 730-4, respectively. Each of the bias-free MZ modulators 730-1 to 730-4 may be implemented per bias-free MZ modulator 400 previously discussed. The multi-channel EO transmitter 700 includes four (4) RF signal ports (RF IN) coupled to electrical inputs of the set of bias-free MZ modulators 730-1 to 730-4, respectively. The set of bias-free MZ modulators 730-1 to 730-4 include outputs coupled to inputs of a 4×1 optical combiner 740, respectively. The 4×1 optical combiner 740 includes an output coupled to or serving as an output port (OPT OUT) of the multi-channel EO transmitter 700.

In operation, the 1×4 optical splitter 720 is configured to receive (via the input optical port (OPT IN)) and split an input optical signal S_{I} (e.g., a CW laser signal) into four (4) unmodulated optical signals S_{IA} to S_{ID}. The unmodulated optical signals S_{IA} to S_{ID} are provided to the optical inputs of the bias-free MZ modulators 730-1 to 730-4, respectively. A set of four (4) RF signals S_{RFA} to S_{RFD} received via the RF input ports (RF IN) are routed to the electrical inputs of the bias-free MZ modulators 730-1 to 730-4, respectively. The bias-free MZ modulators 730-1 to 730-4 are configured to modulate the optical signals S_{IA} to S_{ID} with the RF signals S_{RFA} to S_{RFD} to generate a set of modulated optical signals S_{OA} to S_{OD}, respectively. The 4×1 optical combiner 740 is configured to receive and combine the modulated optical signals S_{OA} to S_{OD} to generate an output optical signal S_{O} at the output port (OPT OUT).

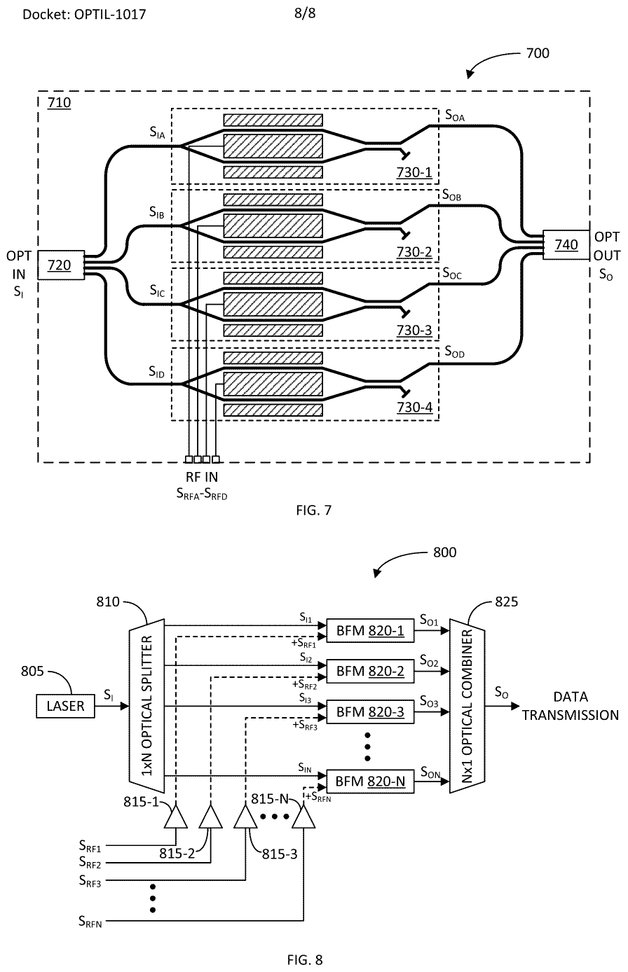

FIG. 8 shows a block diagram of an example multi-channel electro-optic (EO) transmitter 800 in accordance with another aspect of the disclosure. The multi-channel EO transmitter 800 includes a laser 805 configured to generate an input optical signal S_{I} (e.g., a CW laser signal). The multi-channel EO transmitter 800 further includes a 1×N optical splitter 810 configured to split the input optical signal S_{I}into a set of N unmodulated optical signals S_{I1} to S_{IN}, respectively. Additionally, the multi-channel EO transmitter 800 includes a set of N RF amplifiers 815-1 to 815-N configured to amplify a set of N input RF signals S_{RF1} to S_{RFN} to generate a set of amplified RF signals +S_{RF1} to +S_{RFN}, respectively.

The multi-channel EO transmitter 800 also includes a set of N bias-free MZ modulators (BFM) 820-1 to 820-N configured to modulate the set of N optical signals S_{I1} to S_{IN} with the set of N amplifier RF signals +S_{RF1} to +S_{RFN} to generate a set of N modulated optical signals S_{O1} to S_{ON}, respectively. Each of the set of bias-free MZ modulators 820-1 to 820-N may be implemented per bias-free MZ modulator 400. The N×1 optical combiner 825 is configured to combine the set of N modulated optical signals S_{O1} to S_{ON} to generate an output optical signal S_{O} for data transmission.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

1. A Mach Zehnder (MZ) modulator, comprising:
an MZ interferometer including an optical signal input, a radio frequency (RF) signal input, a first optical signal output, and a second optical signal output; and
a directional coupler, comprising:
a first optical waveguide coupled between a first port and a second port, wherein:
the first optical waveguide includes a first segment with a first index of refraction coupled in series with a second segment with a second index of refraction,
the first port is coupled to the first optical signal output of the MZ interferometer, and
the second index of refraction is different than the first index of refraction; and
a second optical waveguide coupled between a third port and a fourth port, wherein:
the second optical waveguide includes a third segment with a third index of refraction coupled in series with a fourth segment with a fourth index of refraction,
the third port is coupled to the second optical signal output of the MZ interferometer, and
the fourth index of refraction is different than the third index of refraction.

2. The MZ modulator of claim 1, wherein:
the first segment is laterally adjacent to and parallel with the third segment; and
the second segment is laterally adjacent to and parallel with the fourth segment.

3. The MZ modulator of claim 2, wherein:
the first index of refraction is greater than the second index of refraction; and
the third index of refraction is less than the fourth index of refraction.

4. The MZ modulator of claim 2, wherein:
the first index of refraction is substantially the same as the fourth index of refraction; and
the second index of refraction is substantially the same as the third index of refraction.

5. The MZ modulator of claim 1, wherein:
a length of each of the first and second segments is substantially half a coupling length of the first optical waveguide; and
a length of each of the third and fourth segments is substantially half a coupling length of the second optical waveguide.

6. The MZ modulator of claim 1, further comprising an output optical waveguide coupled to the second port of the directional coupler.

7. The MZ modulator of claim 1, further comprising an optical termination coupled to the fourth port of the directional coupler.

8. The MZ modulator of claim 1, wherein the first and second optical waveguides are formed within an electro-optic (EO) material.

9. The MZ modulator of claim 8, wherein the EO material comprises lithium niobate (LN).

10. The MZ modulator of claim 1, wherein the MZ interferometer comprises:
a first interferometer optical waveguide;
a second interferometer optical waveguide;
a signal coplanar electrode laterally situated between the first and second optical waveguides;
a first ground coplanar electrode, wherein the first interferometer optical waveguide is laterally situated between the signal coplanar electrode and the first ground coplanar electrode; and
a second ground coplanar electrode, wherein the second interferometer optical waveguide laterally situated between the signal coplanar electrode and the second ground coplanar electrode.

11. The MZ modulator of claim 10, further comprising an optical splitter including an input configured to receive an input optical signal, and first and second outputs coupled to respective first ends of the first and second interferometer optical waveguides, wherein the first and second interferometer optical waveguides include respective second ends coupled to the first and third ports of the directional coupler, respectively.

12. The MZ modulator of claim 10, wherein the signal coplanar electrode includes a first end configured to receive a radio frequency (RF) signal, and wherein the MZ interferometer further includes a termination resistor coupled between a second end of the signal coplanar electrode and ground.

13. A Mach Zehnder (MZ) modulator, comprising:
an MZ interferometer configured to modulate an input optical signal with a radio frequency (RF) signal to generate first and second modulated optical signals without being biased with a bias voltage; and
a directional coupler configured to combine the first and second modulated optical signals to generate an output optical signal whose power varies substantially linear with an amplitude of the RF signal, wherein the directional coupler comprises:
a first optical waveguide, wherein:
the first optical waveguide includes a first segment with a first index of refraction coupled in series with a second segment with a second index of refraction, and
the second index of refraction is different than the first index of refraction; and
a second optical waveguide, wherein:
the second optical waveguide includes a third segment with a third index of refraction coupled in series with a fourth segment with a fourth index of refraction, and
the fourth index of refraction is different than the third index of refraction.

14. The MZ modulator of claim 13, wherein:
the first optical waveguide is coupled between a first port and a second port;
the first port is configured to receive the first modulated optical signal;
the second optical waveguide is coupled between a third port and a fourth port; and
the third port is configured to receive the second modulated optical signal.

15. The MZ modulator of claim 13, wherein:
the first segment is laterally adjacent to and parallel with the third segment; and
the second segment is laterally adjacent to and parallel with the fourth segment.

16. The MZ modulator of claim 13, wherein:
the first index of refraction is greater than the second index of refraction; and
the third index of refraction is less than the fourth index of refraction.

17. The MZ modulator of claim 13, wherein:
the first index of refraction is substantially the same as the fourth index of refraction; and
the second index of refraction is substantially the same as the third index of refraction.

18. The MZ modulator of claim 13, wherein:
a length of each of the first and second segments is substantially half a coupling length of the first optical waveguide; and
a length of each of the third and fourth segments is substantially half a coupling length of the second optical waveguide.

19.-20. (canceled)
